(19) United States
(12) Patent Application Publication
(10) Pub. No.: US 2004/0054698 A1
(43) Pub. Date: Mar. 18, 2004

(54) Layered computer system with thin clients

(75) Inventors: Naoko Iwami, Sagamihara (JP); Masayuki Yamamoto, Sagamihara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/247,150

(22) Filed: Sep. 18, 2002

(51) Int. Cl. G06F 17/30

(52) U.S. Cl. 707/204

(57) ABSTRACT

A layered computer system is described in which a central storage system is mirrored to multiple local storage systems for use by thin clients. The system enables the distribution and management of data from a central storage to the multiple local computer systems by using storage-based remote copy technology. The local storage systems provide operating system software, application software, and data to the thin clients. Mirroring of the data between the central storage and the local storages enables a more efficient management of the distributed computer system.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

This invention relates to computer systems, and in particular to a layered computer system which includes a central storage system, a group of local storage systems, and a series of client computers interfaced to the local storage system. In particular, the invention relates to a method and system for distributing and managing data among the central storage, the local storage, and the local computer systems by using storage-based remote copy technology.

In today's international business, large enterprises employ huge computers to manage their data processing needs. A present issue for such management, however, is decreasing the total cost of ownership of such huge computers. Each of these computers has a high performance central processing unit, a very large memory, and multiple disk drives. Extensive duplication of data is present throughout the organization. One approach to reducing the cost of ownership is known as the “thin client system.” In a thin client system a central server provides multiple thin clients with an operating system, application programs, and the data necessary for the client to carry out the desired tasks. In these systems, the thin client typically does not have a disk drive for storing data, and the thin client typically accesses the central server when it is turned on to retrieve the desired application programs.

Even though the such thin client systems reduce the costs of managing a data processing network, it is still difficult to manage a large number of thin clients in a large enterprise. As a result of the heavy load of accesses to the central system from the thin clients, the thin clients are not always a scalable solution. Thus, in large scale enterprises, the thin client solution is typically used for a division of the corporation, or a smaller portion of a division, such as a group.

What is needed is a more sophisticated management solution for multiple thin clients. Such a management system would enable administrators managing thin clients to distribute consistent data from a central storage to multiple central servers for use by the multiple thin clients.

### BRIEF SUMMARY OF THE INVENTION

In a preferred embodiment of this invention, a central system is provided which includes a central storage and a central storage manager. Remotely situated from the central storage, and typically connected thereto by a network, are a series of local storage management systems. The local storage management systems typically include local storage, for example, on arrays of hard disk drives, and storage management, for example, a server. The thin clients, employed by the users of the computer system, are then coupled through an appropriate network to the local storage from which they retrieve application software, data, and other aspects necessary for operation.

The central storage manager and the local storage managers communicate with each other to keep the data in the local storage fresh. To maintain consistency of the data among the central storage and the local storages, in the preferred embodiment storage-based remote copy technology is employed. By using storage-based remote copy technology, no network server operation is required to maintain the consistency of the data among the central and local storage volumes.

In a preferred embodiment of our invention, three procedures are employed for maintaining the consistency among the local and remote volumes. These three procedures are initialization (creation of paired volumes), resynchronization in response to a request from a thin client, and scheduled resynchronization. Preferably, the invention is applicable to two types of systems. In one type of system wherein the operating system software and the application software is distributed, the central storage provides a thin client management center. It centrally manages the operating systems and application software configuration for all of the thin clients and distributes data to those thin clients when needed or requested. In a second type of system to which the invention is applicable, a data distribution system for separating online transactions from other transactions is provided. In this circumstance the central system performs the online transactions and produces the data for analysis, for example by a customer relationship management or data mining software. In this circumstance, the central system carries out the online transactions without any effect on the data analysis performed by the multiple thin clients.

Thus, in a preferred embodiment a layered computer system includes a central system having a central storage manager and a central storage, a local system having a local storage manager and a local storage, the local system being coupled to the central system, and a plurality of thin client systems, each of the thin client systems being coupled to the local system. Remote copy operations are used to mirror the central storage to the local storage for use by the thin clients.

### BRIEF DESCRIPTION OF THE DRAWINGS

FIG. 1 is a diagram illustrating an overall configuration of a thin client system according to a preferred embodiment;

FIG. 2 is a block diagram illustrating the central storage management server;

FIG. 3 is a diagram illustrating the volume management table in the central storage manager;

FIG. 4 is a diagram illustrating the local storage management server;

FIG. 5 is a diagram illustrating the volume management table in the local storage manager;

FIG. 6 is a flowchart illustrating operations within the central storage manager;

FIG. 7 is a more detailed flowchart of one of the steps in FIG. 6;

FIG. 8 is a more detailed flowchart of another of the steps in FIG. 6;

FIG. 9 is a more detailed flowchart of a third one of the steps in FIG. 6;

FIG. 10 is a diagram illustrating one application for an embodiment of the thin client system; and

FIG. 11 is a diagram illustrating another application for an embodiment of the thin client system.

### DETAILED DESCRIPTION OF THE INVENTION

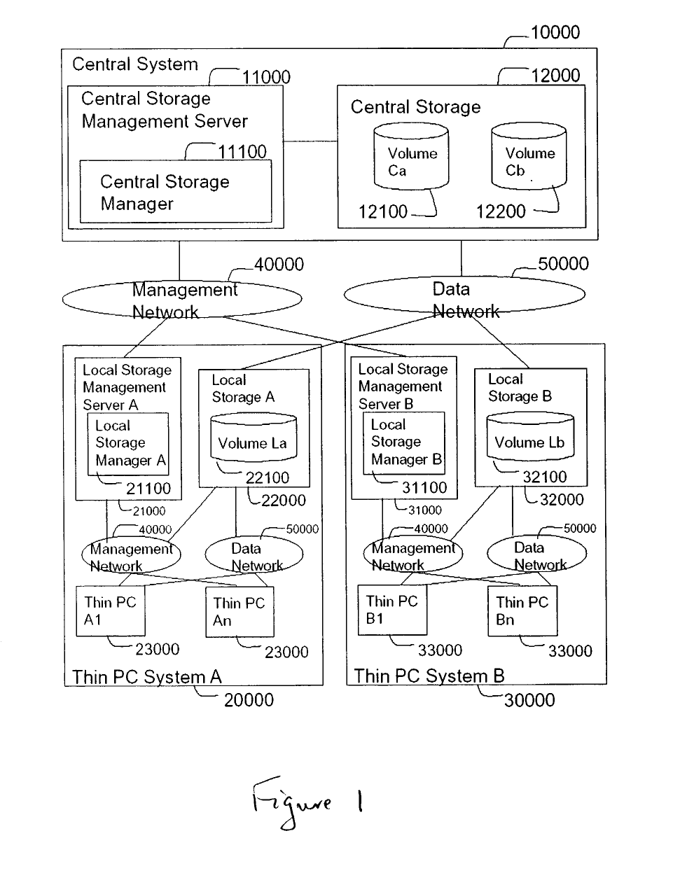

FIG. 1 is a diagram which illustrates an overall configuration of a system according to the preferred embodiment of this invention. The system illustrated in FIG. 1 includes several basic subsystems. As shown at the top of the figure, a central system 10000 includes a central storage management server 11000, and a central storage 12000 typically will consist of a number of volumes 12100, 12200, etc. Although only one central storage with two volumes is depicted in FIG. 1, as many as desired may be employed, and each individual central storage may be made as large as desired. The multiple volumes in the central storage each consists of single physical disk drives, or of multiple disk drives, where the data is striped and managed by a disk array controller in a conventional manner. In the particular system described herein, the physical structure of the volume, particular redundancy techniques employed, etc., are not pertinent; any well known approach may be employed.

The central storage is controlled and managed by a central storage management server 11000 which includes a central storage manager. The server and manager control all volumes within the central storage, and in particular manage the central and remote volumes (discussed below) in the system.

FIG. 1 also illustrates two thin client systems 20000, 30000 as coupled to the central system 10000. In the illustration these thin client systems are designated thin PC system A and thin PC system B. (Herein the terms “thin client” and “thin PC” are used interchangeably.) Although only two thin client systems are illustrated, as many as desired may be employed. Typically, as mentioned above, one of the thin client systems 20000, 30000 will be used by a group or a division of a business, and the other will be similarly employed.

Each of the thin client systems is coupled to the central system via a management network 40000 and a data network 50000. The management network provides a network for communicating management information between the central and local storage management servers, located within the thin client systems. In the depicted embodiment, the control messages for certain storage operations to be described below, are transmitted via the management network.

A data network 50000 provides an interconnection among the central system and the thin client systems for employing storage-based remote copy technology. The data network can comprise a fibre channel interconnection, an Ethernet network, an ATM connection, a wireless network, or even the internet itself. In short, the particular physical or virtual connection among the components can be any suitable connection so long as management and data information are transmittable among the various subsystems.

As shown in FIG. 1, each of the thin client systems 20000, 30000 itself includes a number of subsystems. Client system 20000 will be described, and it will be appreciated all of the other subsystems are similarly configured. Thin client system 20000 includes a local storage 22000 and a local storage management server 21000. Just as a central storage 12000 included a number of volumes, the local storage 22000 may also include a number of volumes. In the depicted embodiment volume 22100 is shown. In the same manner that the central storage management server 21000 controls the central storage, the local storage management server 21100 controls the local storage 22000. The management network couples the local storage management server to the central storage management server, and the data network couples the local storage 22000 to the central storage 12000. Multiple thin clients or thin PCs 23000 are then coupled to the local storage and local storage management server. In the depicted embodiment, 1 to n thin clients are illustrated. Each thin client is a client which typically will not have a local disk drive, or a bootable operating system, application software or data. Instead, the local storage 22000 will provide all of the data, operating system and application software for the thin clients. Beneficially to the total cost of ownership, this means that the maintenance and upgrading of the software only need be done in one location, and yet is accessible to all of the thin clients coupled to that network.

In the same manner that the management and data networks couple the central system and the local systems, a management network and data network couple the thin clients 23000 to the local storage management 21000 and local storage 22000. As described above, these network interconnections may constitute wired or wireless networks to provide the desired capability for the thin clients.

Data transfer among the central storage and the local storage systems is preferably achieved using storage-based remote copy technology. This technology is well known and generally described, for example, in U.S. Pat. Nos. 5,459,857 and 5,544,347. Remote copy technology allows two storage systems to be connected by remote links, but separated at a distance, yet remain congruent in the sense of maintaining the same data. In general, the local storage subsystem will copy data it receives onto a local volume when the control system designates that a “pair” is to be created. A “pair” typically consists of a volume mirrored from the central location to the remote location. At the time the pair is created, the host will update the data on the volume to be copied, and the local storage subsystem will transfer that data to the remote storage subsystem through a remote link, such as mentioned above. In this manner, when a host updates data on a volume in central storage, the local storage subsystem can receive that data through a link. Thus, no host operations are required to maintain the two volumes in what is termed a “mirrored” condition. An example of a commercial product providing remote copy technology is the Hitachi Lightening 9900 as provided by Hitachi Data Systems.

A storage-based remote copy system typically defines the status of a pair of volumes in the local and remote storage subsystems. In the vernacular of storage systems, “initial” is a first state for the volume pair. When users create the pair, the local subsystem begins copying data to the remote volume. This is referred to as “initial copy.” During this operation the remote volume is not consistent with the local volume—data is still being transferred. Once the initial transfer is completed so that the data on the two systems approximately match, the status is changed to “pair.” This means that the remote volume is now consistent with the local volume. Thus, if users wish to access the data at the remote volume at the remote site, they can “split” the pair and use the data. If, while this is occurring, the local volume is updated, or additional data transferred to it, the local volume is updated during the split status. In this case, the local storage subsystem maintains a record of the update, and then stores the needed changes onto the remote and local volume when they can be again paired. When users wish to resynchronize the pair of local and remote volumes, the pair can be connected together and only the differences between them used for the update. This is referred to as “resynchronization.”

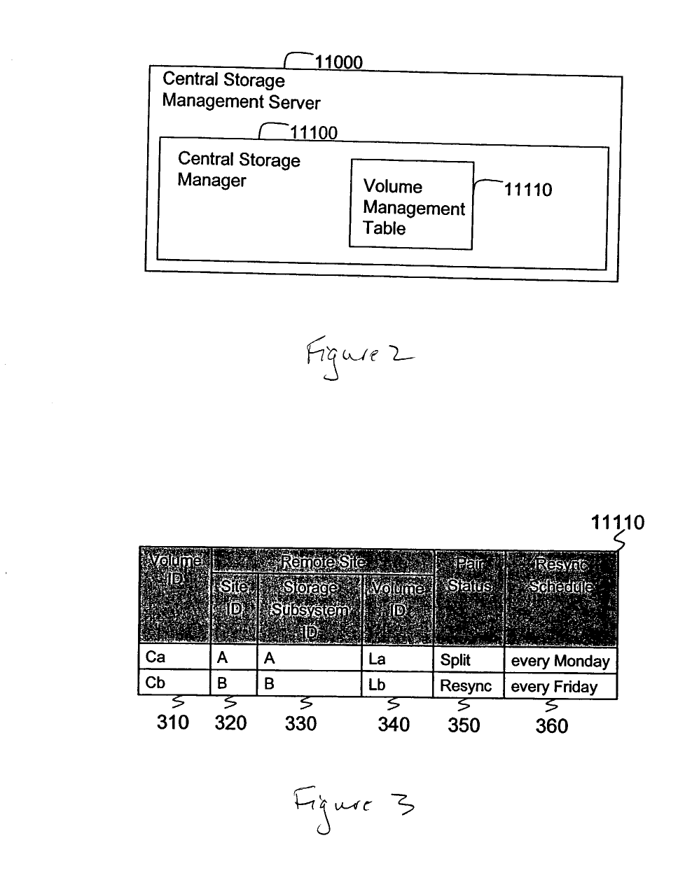

FIG. 2 is a more detailed view of the configuration of the central storage management server 11000. As shown, the server 11000 includes a central storage manager 11100 and a volume management table 11110. The storage manager 11100 controls all of the volumes of the attached storage (shown in FIG. 1). In particular, it manages the central and remote volumes; in other words, it assures the appropriate mirroring activities between the central storage 12000 and the local storages in the various thin client systems.

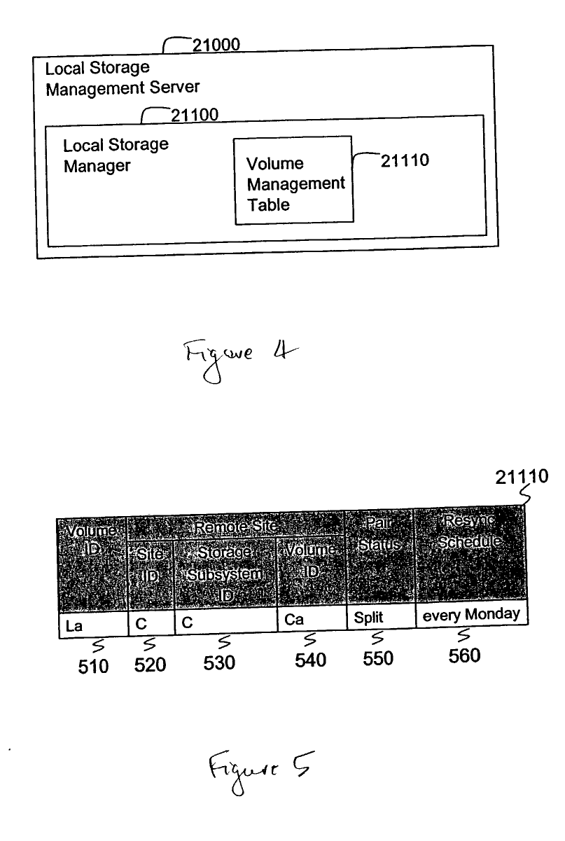

To manage the remote copy pair, i.e., the thin client local storage, the storage manager 11100 includes a volume management table 11110. This table provides information for the paired volumes configured as remote copy pairs. FIG. 3 illustrates the volume management table 11110. As shown there, the table preferably includes six columns. In the first column, identification for the particular volume is provided. For example, for storage manager 11100 the volume IDs are Ca and Cb as shown in the two rows. The remaining portion of the table then contains information about those two volumes.

The next three columns at the table refer to the remote site. These columns include the site identification, the storage subsystem identification and the volume identification. For example, with reference to FIG. 1, as shown in the table, volume Ca is mirrored at remote site A (i.e., thin client system A) in local storage A on volume La. In FIG. 3 the columns maintaining the remote site information are designated as 320, 330 and 340. The column with the volume identification is designated 310.

Column 350 maintains an indication of the pair status. As described above, in the preferred embodiment, the pair status will be one of initialize, pair, split, or resynchronize. Finally, column 360 maintains the resynchronization schedule. As shown there, the volume ID Ca is to be resynchronized with the volume ID La every Monday. Of course, a specific date, time, or even an event, could be used as the resynchronization scheduling event.

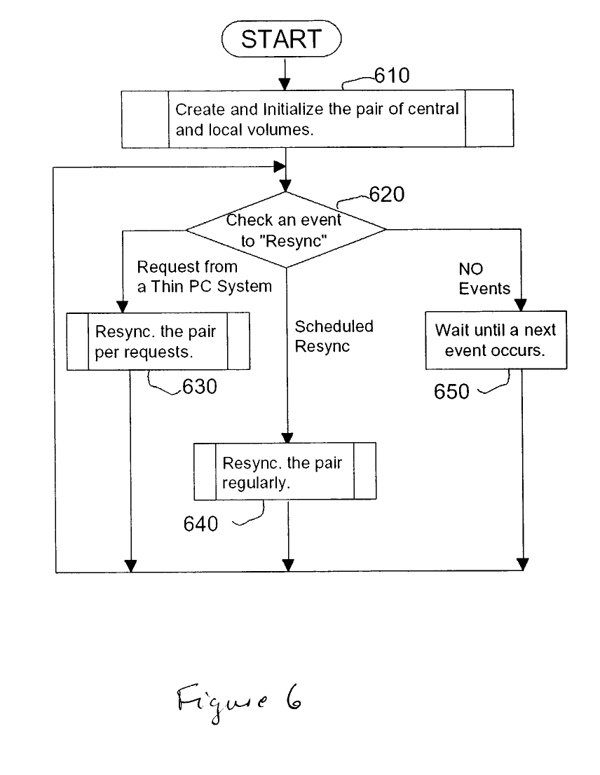

FIG. 4 illustrates in more detail the configuration of the local storage management server 21000. As shown, it includes a local storage manager 21110 and a volume management table 21110. As described, the local storage management server is of the same architecture as the central storage management server 11000.

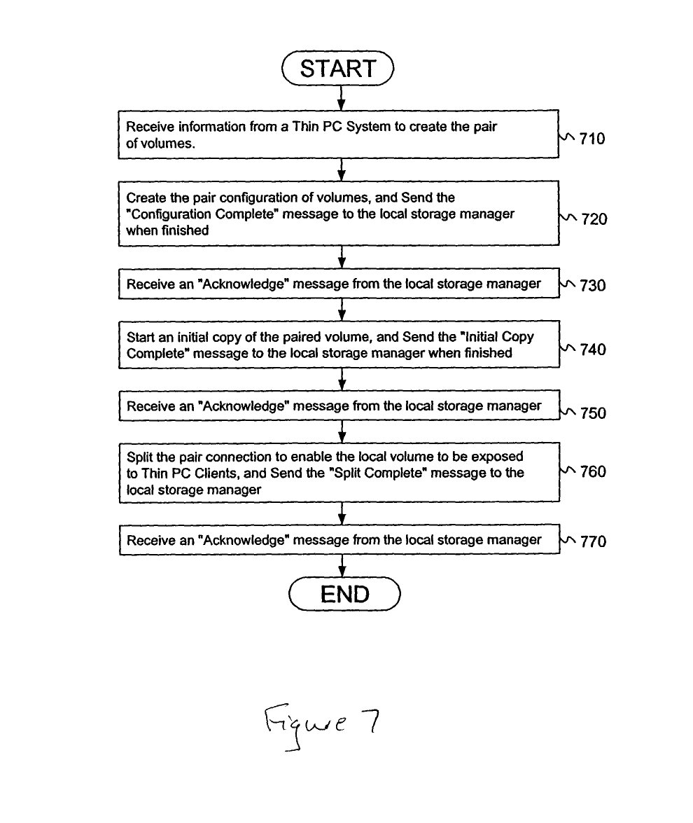

FIG. 5 is a volume management table 21110 as maintained within the local storage manager 21100. This table corresponds to the table discussed above in FIG. 3. In the case of this table, however, the reference is from the local viewpoint, in other words, the volume identification La is the local volume, and the central storage 12000 is referred to as the remote site. Thus, as shown by 21110, volume ID La in column 510 is mirrored with remote site C, storage subsystem C, and volume ID Ca in the central storage. The pair status is shown in column 550 as split, and the resynchronization schedule is shown in column 560.

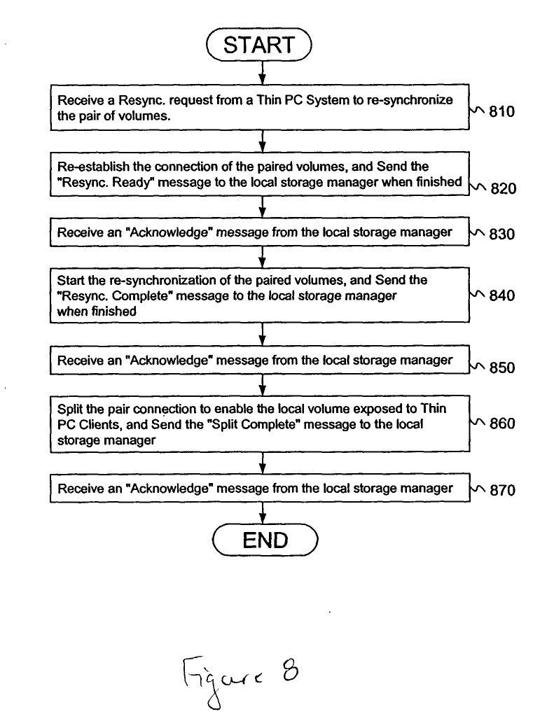

FIG. 6 is a diagram of the general processing flow of the central storage manager 1000. Some of the individual steps in FIG. 6 are described in more detail in conjunction with FIGS. 7, 8 and 9. Those steps for which additional detail is provided in other figures are illustrated in FIG. 6 with a block which has been subdivided into three blocks—one wide block with the description of that step and two narrow blocks which are empty. As shown in FIG. 6, the central storage manager processing starts with a step 610 in which a pair of central and remote volumes are created and initialized. For example, in this step, the pair of volumes Ca and La will be created, and copying will begin from volume Ca to volume La.

As shown by step 620, after creating and initializing the pair, the central storage manager 11100 monitors events from the thin client system 20000 and/or monitors the schedule for resynchronization. If the central storage manager receives a resynchronization request from a thin client system, the process flow moves to step 630. At this step the storage manager detects the scheduling for a resynchronization operation and then continues. On the other hand, if at step 620 no request has been received from a thin client system, at the appropriate time the scheduled resynchronization is performed as shown by step 640. Finally, as shown by step 650, in the event that neither a thin client requests resynchronization, and no resynchronization is scheduled for the present time, then the system waits for the next event as shown by step 650.

FIG. 7 is a more detailed flow chart of the steps involved in step 610 of FIG. 6. As shown in FIG. 7 the process for creating and initializing a pair of central and local volumes begins with receipt of information from a thin PC system to create the pair of volumes at step 710. This step will originate from either a system administrator command or a user command to access data or application software found in the central storage. The request is followed, as shown in step 720, by creation of the pair and sending an acknowledgment message “configuration complete” to the local storage manager when creation of the pair is completed.

At step 730 the local storage manager acknowledges receipt of the message. The central storage manager then begins initializing the paired volume by copying data from the source volume to the target volume. When complete, as shown by step 740, the storage manager sends the “initial copy complete” message to the local storage manager. At step 750 the local storage manager acknowledges the message.

As shown by step 760, the next process is for the pair to be split. Splitting of the pair enables the local volume to be exposed to the thin PC clients for use by them. Once the split is complete, an appropriate message is sent to the local storage manager from the central storage manager. Upon receipt of the acknowledge message, as shown by step 770, the process is complete.

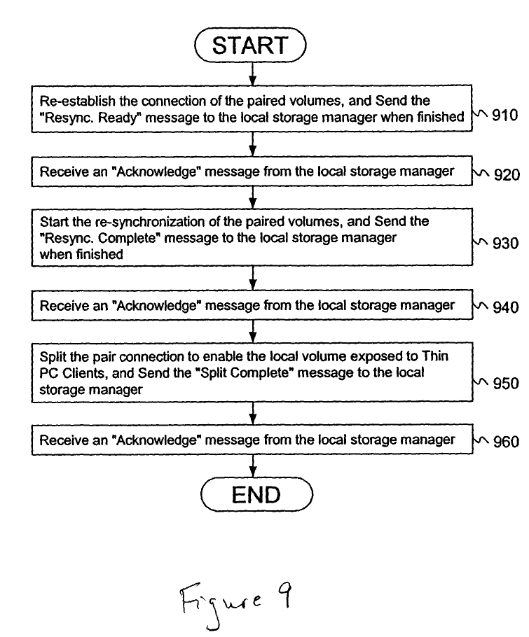

FIG. 8 is a flowchart which provides more detail with respect to the specific operation of step 630 in FIG. 6. Step 630 is the step at which resynchronization of a pair is performed. As shown by FIG. 8, the process begins at step 810 at which a request for resynchronization is received from a thin PC system. In response, at step 820, the pair volumes are reconnected, and a resynchronization ready message is sent to the local storage manager, once the connection is established.

At step 830 the local storage manager acknowledges the message, and at step 840 begins resynchronizing the paired volumes. Once the resynchronization is complete, a suitable message is sent to the local storage manager from the central storage manager. This message is acknowledged at step 850. At step 860 the pair is again split to enable the local volume to be exposed to the thin clients. Once split, a message “split complete” is sent to the local storage manager. The process is complete when the local storage manager acknowledges receipt of the message at step 870.

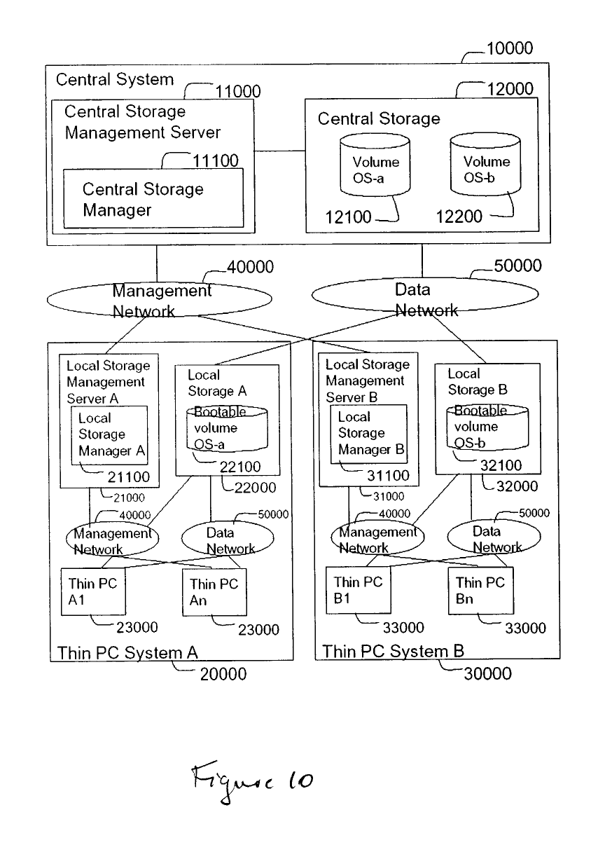

FIG. 9 is a more detailed flowchart of step 640 in FIG. 6. Step 640 is the step at which the pair is resynchronized pursuant to a schedule. The steps in FIG. 9 are exactly the same as those in FIG. 8, except that the process is triggered by a timer or other event, not by a request from a thin client to resynchronize the pair of volumes. Thus, steps 910-960 in FIG. 9 correspond to steps 820-870 in FIG. 8.

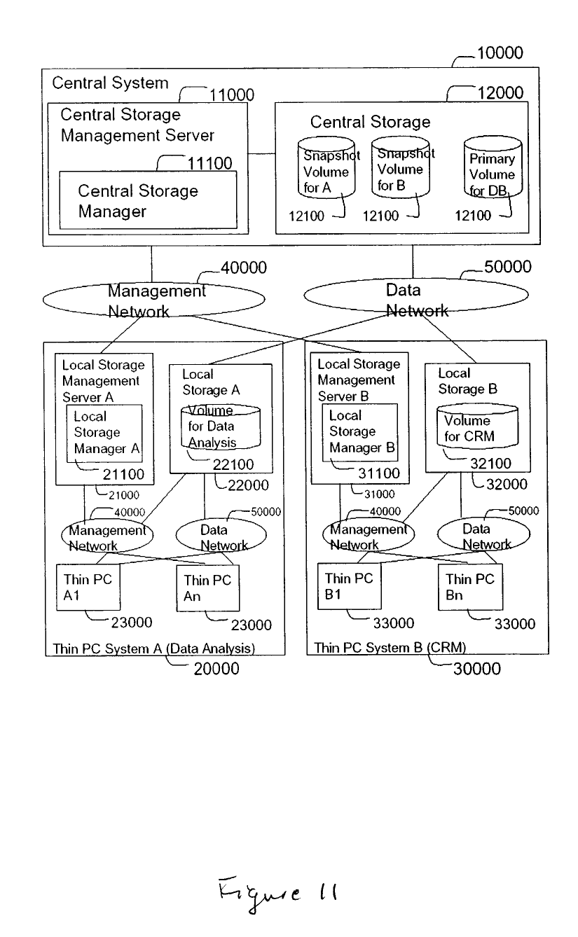

FIGS. 10 and 11 illustrate applications for a thin client or thin PC system such as has been described above. In each case, the overall architecture of the system is similar to that of FIG. 1, and includes a central system coupled to local systems via a management network and a data network.

FIG. 10 illustrates an example of a thin client system in which operating system software and application software is distributed. In this example two operating systems are stored in the central storage, an operating system “a” in volume 12100 and an operating system “b” in volume 12200. The thin client system 20000 uses operating system a, while the thin client system 30000 uses operating system b. The central system functions as a thin client management center. It centrally manages the operating system software and the application software configuration for all of the thin client systems. It distributes the program data when needed. For example, it places a bootable volume of operating system a on local storage A, for thin clients 23000 to use as their bootable operating system a. In a similar manner, the central storage of operating system b places a copy of that on the local storage volume 32100. This copy of operating system b is then used as the bootable volume for thin PCs 33000. By operating in this manner, only one copy of the operating system and application software needs to be maintained, and that copy is on the central storage. All other functions automatically mirror that copy to the various local storage volumes where each thin client can access it and use it as needed.

FIG. 11 is a diagram illustrating another application for a thin client system. In this example, it is desired to separate the online transactions from other transactions. In this example the central storage includes a snapshot volume for thin client system a and another one for thin client system b. It also includes a primary volume for storage of database information. In this example the central system performs the online transactions, and produces the data for analysis offline, for example by customer relationship management or data mining software. Thin client systems a and b are the consumers of the data and analyze it in whatever manner is desired by the users of both systems. By employing snapshot technology inside the storage subsystem, the central storage creates multiple copies, each at a different point in time, for consumers to use. Because of the difficulty of a consumer in using that data from multiple remote sites, the invention enables the data distribution to those thin clients without disruption of online transactions.

The preceding has been a description of the preferred embodiments of the system of this invention. It should be appreciated, however, that the scope of the invention is defined by the appended claims.

What is claimed is:

1. A layered computer system comprising:
a central system having a central storage manager and a central storage:
a local system having a local storage manager and a local storage, the local system being coupled to the central system;
a plurality of thin client systems, each of the thin client systems being coupled to the local system; and wherein remote copy operations are used to mirror the central storage and the local storage for use by the thin client systems.

2. A system as in claim 1 wherein the central system is coupled to the local system by a network and the thin clients are coupled to the local system by the network.

3. A system as in claim 1 wherein the central storage and the local storage are organized into volumes.

4. A system as in claim 3 wherein the central storage manager and the local storage manager each contain a volume management table to control the mirroring of the central storage and the local storage.

5. A system as in claim 1 wherein applications software for operation of the thin client systems is maintained in the central storage and mirrored to the local storage for use by the thin clients.

6. A system as in claim 5 wherein data for use by the thin client systems is maintained in the central storage and mirrored to the local storage for use by the thin clients.

7. A system as in claim 6 wherein the local storage is disconnected from the central storage when the thin clients are able to access the local storage.

8. A system as in claim 2 wherein the network provides a connection for both management information and data to be transmitted between the central system and the local system.

9. A method of providing digital information to a plurality of thin client systems comprising:
establishing a central storage for storing the digital information;
establishing a local storage for also storing the digital information, the digital information stored on the local storage being stored there by a remote copy operation to copy the information from the central storage to the local storage; and
providing the information from the local storage to the plurality of thin client systems.

10. A method as in claim 9 wherein the local storage is disconnected from the central storage when the thin clients are able to access the local storage.

11. A method as in claim 9 wherein the step of providing the information from the local storage to the plurality of thin client systems comprises transmitting the information over a network.

12. A method as in claim 11 wherein the remote copy operation is performed over a network.

13. A method as in claim 12 wherein both the central storage and the local storage have volumes upon which data is stored, and the remote copy operation includes the step of creating a pair of volumes and making an initial copy from a volume in the central storage to a volume in the local storage.

14. A method as in claim 13 further comprising a subsequent step of synchronizing the contents of the volume in the central storage and the volume in the local storage.

15. A method as in claim 14 wherein the step of synchronizing includes sending messages between the central storage and the local storage.

16. A storage system for providing digital information to a plurality of thin client systems which are connectable to a network, the storage system comprising:
a local storage having at least one volume;
a local storage manager for managing the local storage, which local storage manager stores volume management information about a volume in a central storage which corresponds to the at least one volume in the local storage;
a control program for writing information onto the at least one local volume which corresponds to the information stored on the volume in the central storage, the control program operating in response to a remote copy command; and
a network connection for enabling connection of the local storage to the central storage.

17. A storage system as in claim 16 wherein the remote copy command causes the volume in the central storage to be mirrored to the at least one volume in the local storage.

18. A storage system as in claim 17 wherein the local storage stores at least one of operating system software, applications software, and data for use by the applications software.

19. A system as in claim 15 wherein applications software for operation of the thin client systems is maintained in the central storage and mirrored to the local storage for use by the thin clients.

20. A system as in claim 19 wherein data for use by the thin client systems is maintained in the central storage and mirrored to the local storage for use by the thin clients.

21. A system as in claim 15 wherein information is only written into the local storage when the thin client systems are not able to access the local storage.
